(19) United States
(12) Patent Application Publication
(10) Pub. No.: US 2004/0209128 A1
(43) Pub. Date: Oct. 21, 2004

(54) Method of operating a fuel cell system

(76) Inventors: Karl-Ernst Noreikat, Esslingen (DE); Alfons Rennefeld, Stuttgart (DE); Volker Sanchen, Stuttgart (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/758,281

(22) Filed: Jan. 16, 2004

(30) Foreign Application Priority Data
Jan. 20, 2003 (DE) 103 01 812.3

(51) Int. Cl. H01M 8/04

(52) U.S. Cl. 429/13; 429/24; 429/26

(57) ABSTRACT

In a method for operating a fuel cell system comprising at least one fuel cell and at least one cooling circuit with devices for influencing the cooling of the at least one fuel cell, a medium which flows through the cooling circuit is cooled by a cooling heat exchanger of the cooling circuit. The operating temperature of the fuel cell is controlled by the cooling, as a function of an ambient temperature of the cooling heat exchanger, such that the heat from the fuel cell is removed at a temperature which is as low as possible.

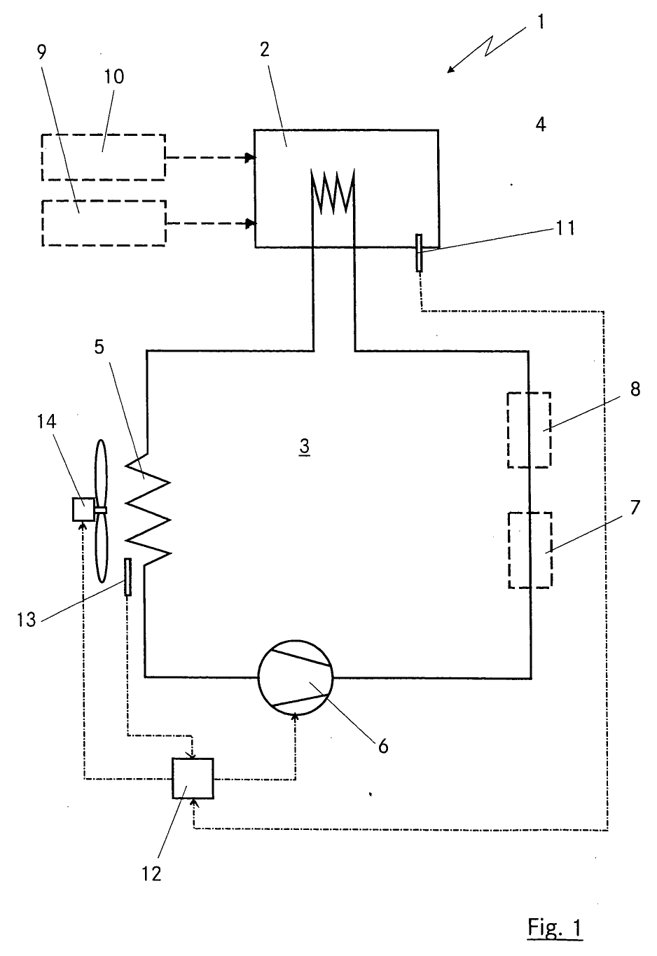

### BACKGROUND AND SUMMARY OF THE INVENTION

This application claims the priority of German patent document 103 01 812.3, filed 20 Jan. 2003 (20.01.2003), the disclosure of which is expressly incorporated by reference herein.

The invention relates to a method of operating a fuel cell system comprising at least one fuel cell and at least one cooling circuit.

Various methods of operating fuel cell systems are known from the general state of the art, in which the fuel cell is normally held at a defined temperature (for example, in the case of a PEM fuel cell, at a temperature of approximately 80° C.). The defined operating temperature of the fuel cell is generally selected so as to insure a sufficient removal of the heat which it generates during its operation. In order to ensure such a sufficient transfer of heat to the environment even at comparatively high loads of the fuel cell (with the associated comparatively high generation of heat), this constant operating temperature will expediently be more in the upper portion of the permitted temperature range for the operation of the fuel cell. In the case of the above-mentioned PEM-fuel cell, this range is between from approximately 55° C. to 95° C.

This operating method has several disadvantages. For example, the service life of fuel cell systems depends on the defined operating temperature. In addition, the operating temperature can also have a disadvantageous effect on the moistening of the electrolyte, for example, the PEM. The higher the operating temperature, the shorter the service life of the corresponding fuel cell system. In addition, it has been found that the efficiency increases as the operating temperature decreases. In the case of a partial-load situation, which occurs frequently in fuel cell systems of this type, particularly when used as an auxiliary power unit (APU) in a motor vehicle, for example, the normally very high operating temperature will therefore degrade the system efficiency.

Concerning the general state of the art, reference is also made to International Patent Application WO 99/16139, which relates to the problems of cooling fuel cells. This application suggests cooling a fuel cell by means of a fluid which thereby changes into a gas, so that comparatively high quantities of heat can be removed.

It is now an object of the present invention to provide a method of operating a fuel cell system which avoids the initially mentioned disadvantages and permits a long service life as well as a high efficiency of the fuel cell system over the entire load range.

This and other objects and advantages are achieved by the operating method according to the invention, in which the operating temperature is controlled (by means of cooling) as a function of the ambient temperature. In this manner, it can be assured that the fuel cell is always operated in such a manner that the load dependent heat is removed at the lowest possible operating temperature. That is, the temperature difference with respect to the ambient temperature, remains just barely sufficient for the removal of the waste heat generated momentarily in the fuel cell.

By such “intelligent” control of the cooling system (by corresponding devices for influencing the cooling of the at least one fuel cell), the operating temperature of the fuel cell itself can be held at its minimum possible value during the entire operation. On the one hand, this technique decisively improves the service life of the fuel cell while, on the other hand, the efficiency of the fuel cell can be correspondingly increased. This is true particularly in partial-load situations, in which little heat is produced and removed, so that a correspondingly low operating temperature can be selected.

In addition, in the case of a high load demand on the fuel cell at a time when it is operated in the presence of a high ambient temperature, so that the resulting heat removal is very poor (a situation which is quite problematic in the case of previous systems), by increasing the operating temperature at least briefly, a very good heat removal can nevertheless be ensured. Since such an increased operating temperature generally occurs in a very time limited manner in comparison with the state of the art, it causes no significant disadvantages with respect to the service life of the fuel cell, especially because the latter can be operated at a much lower operating temperature for a very long time. The method according to the invention thus avoids the problems of overheating and the associated drying-out of the PEM due to insufficient heat removal, which seriously impair the service life of the fuel cell in the case of the state of the art.

A particularly advantageous use for the method according to the invention is in the operation of a fuel cell system in a motor vehicle, especially on land. However, in principle, the method is also useful on water or in the air.

The fuel cell system in the motor vehicle may be a vehicle driving system or a so-called APU (auxiliary power unit). Highly dynamic demands on the load profile and frequent partial-load operation are typical of such applications in motor vehicles. Since, as explained above, the method according to the invention has significant advantages with respect to efficiency and service life of the fuel cell, particularly when used in the partial-load operation and when occasional peak loads occur, decisive advantages are achieved as a result of the close union with the vehicle.

A “fuel cell” in the sense of the invention is an individual fuel cell; it also includes, however, a fuel cell stack, which is constructed of a plurality of individual fuel cells but normally does not necessarily have a single common cooling circuit. Further, a “fuel cell system” refers to the fuel cell or the fuel cell stack with its corresponding peripheral elements, which may (but need not necessarily) comprise a gas generating system for generating a hydrogen-containing gas for operating the fuel cell from hydrocarbons or alcohols, for example.

Other objects, advantages and novel features of the present invention will become apparent from the following detailed description of the invention when considered in conjunction with the accompanying drawings.

### BRIEF DESCRIPTION OF THE DRAWINGS

The single figure illustrates an example of a fuel cell system according to the invention.

### DETAILED DESCRIPTION OF THE DRAWINGS

The single attached figure is a schematic diagram of an example of a fuel cell system 1. One essential component of the invention is a fuel cell 2 which is shown in the form of a PEM fuel cell or a PEM fuel cell stack. In a cooling circuit 3 a medium flows which cools the fuel cell 2 by way of a heat exchanger 4. In addition to the heat exchanger 4 in the area of the fuel cell 2, the cooling circuit 3 also includes an additional cooling heat exchanger 5 and a coolant delivery device 6 as well as additional components 7, 8 which are not relevant to the invention illustrated here and which will not be discussed in detail. However, in principle, the latter may be cooling devices for the recooling of water or water vapor present in the exhaust gases of the fuel cell 2, devices for the charge air cooling, or the like.

The operating media required for the operation (such as oxygen and hydrogen, or air and hydrogen-containing gas) are supplied by the components 9, 10 in the figure. However, since these are of no interest for the method according to the invention, they will also not be discussed here in detail.

The fuel cell 2 may be, in particular, a low-temperature fuel cell, such as a PEM fuel cell, in which case hydrogen or a hydrogen-containing gas can be supplied from a pressure reservoir or from a gas generating system. Oxygen can be supplied by feeding air to the fuel cell 2.

The cooling circuit 3 described in detail above is used for correspondingly removing heat formed in the area of the fuel cell 2, in order to set a corresponding operating temperature therein. The development of heat in the fuel cell 2 will depend on the load applied to it, and thus the electric power demanded from it. The operating temperature currently existing in the fuel cell can be detected, for example, by means of a temperature sensor 11, as indicated in the figure, and can be fed to an analyzing device 12.

As noted previously, in the conventional systems according to the state of the art, the cooling circuit 3 is operated such that a constant operating temperature is set in the area of the fuel cell 2; in the case of PEM fuel cell systems, usually in the range of from 80° C. to 90° C. Such a comparatively high temperature level (in principle, a PEM fuel cell can be operated at temperatures as low as 55 to 60° C.) is provided according to the state of the art to ensure that the heat formed in the fuel cell 2 can be removed to the environment by way of the cooling heat exchanger 5. For this purpose, a corresponding temperature difference is required relative to the ambient temperature of the cooling heat exchanger 5. Since, at high loads, a comparatively large amount of waste heat is generated in the fuel cell 2, in such conventional systems a high operating temperature must be selected, in order to ensure the removal of the heat from the fuel cell 2 during the entire operation of the fuel cell 2.

In contrast, in the method according to the invention, the fuel cell system 1 includes a second temperature sensor 13 which detects the ambient temperature of the cooling heat exchanger 5, so that the temperature difference between the operating temperature of the fuel cell 2 and the ambient temperature of the cooling heat exchanger 5 in the control device 12 is known. As a function of the load of the fuel cell 2, which is also known, and which is accessible to the control device in a manner not shown, the cooling circuit 3 can now be operated such that a temperature difference occurs between the fuel cell 2 and the ambient temperature of the cooling heat exchanger 5 which, on the one hand, ensures the removal of the heat currently forming in the fuel cell 2 and which, on the other hand, sets the minimum fuel cell operating temperature which is necessary for this purpose.

Such minimum operating temperature is of course limited at the lower end by the minimum possible operating temperature of the fuel cell 2 (in the case of the PEM fuel cell, approximately 55° C. to 60° C.). A limitation in the upward direction also takes place by the operating temperature of the fuel cell 2 which may occur at least for a short time and which, in the PEM is, in turn, in the range of approximately 95° C.

Within this range of the possible operating temperatures of the fuel cell 2, the operating temperature which is finally ensured by the cooling circuit 3, can then “intelligently” adapt according to the above-described requirements. The operating temperature of the fuel cell 2 is thus always defined by the cooling circuit in such a manner that the temperature difference between the temperature in the medium in the area of the cooling heat exchanger 5 flowing through the cooling circuit 3 and the ambient temperature in the area of the temperature sensor 13 is just barely sufficient for ensuring the removal of the waste heat occurring as a function of the electric load in the fuel cell 2 and entered into the medium.

Correspondingly, there are various ways in which the cooling circuit 3 can influence the operating temperature in the fuel cell 2. Devices for controlling cooling of the fuel cell 2 in the cooling circuit 3 may be constructed in a known manner. For example, it is possible to adjust the flowing-through or the volume flow of the coolant. In the figure, this is outlined by the coupling of the control unit 12 with the coolant delivery device 6, which can be controlled in its delivery flow volume. However, in principle, this is not required. A throttle with a controllable cross-section, or the like could also be used.

Alternatively, or in addition to, influencing of the volume flow, it is also possible to regulate the convection in the area of the cooling heat exchanger 5. When such a fuel cell system 1 is used in a motor vehicle, the cooling heat exchanger 5 may, for example, be a finned radiator or the like cooled by the air stream. If the cooling capacity generated by the air stream, which cools the medium and correspondingly removes the heat, is not sufficiently high, it can be aided, for example, by a fan 14 which increases the convection such that the desired temperatures is set in the area of the fuel cell 2. Instead of the fan 14 (or in combination therewith), it is also possible to regulate the convection by changing the size of the surface of the cooling heat exchanger 5 against which the flow can take place. This can be achieved, for example, by correspondingly opening and closing fins in front of the cooling heat exchanger 5, so that different volume flows of the air stream cool this cooling heat exchanger 5.

In addition to the initially described favorable characteristics with respect to the service life, the efficiency and the heat management of the fuel cell, a detailed examination of the construction represented in principle by the embodiment reveals that a clear improvement of the fuel cell system 1 is achieved which has no influence on the weight and constructional volume of the fuel cell system because all components are utilized in any event. Slightly higher expenditures are required only in the area of the control 12. However, these expenditures are not too high in comparison to conventional systems, so that, with respect to a cost comparison, the advantages to be achieved be far outweigh the economic disadvantages.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of operating a fuel cell system having at least one fuel cell whose operating temperature is regulated by a cooling circuit that includes a cooling heat exchanger, said method comprising:
detecting an ambient temperature of the heat exchanger;
defining operating temperature of the at least one fuel cell as a function of said ambient temperature of the cooling heat exchanger, such that waste heat of the at least one fuel cell is removed at a lowest operating temperature at which such removal is possible; and
said cooling circuit controlling said operating temperature of the at least one fuel cell, to achieve said defined operating temperature.

2. The method according to claim 1, wherein:
the at least one fuel cell comprises a PEM fuel cell; and
the fuel cell is operated at an operating temperature between 95° C. and 55° C.

3. The method according to claim 1, wherein the volume flow of a cooling medium flowing in the cooling circuit is controlled by devices for influencing the cooling of the at least one fuel cell.

4. The method according to claim 3, wherein convection of a gas flowing around the cooling heat exchanger is influenced by the devices for influencing the cooling of the at least one fuel cell.

5. The method according to claim 4, wherein the gas is air.

6. The method according to claim 1, wherein the operating temperature of the at least one fuel cell is defined such that a temperature difference between a cooling medium flowing in the cooling circuit at the cooling heat exchanger and said ambient temperature is maintained at a minimum value that is sufficient to ensure removal of the waste heat generated as a function of the electric load at the at least one fuel cell.

7. The method according to claim 1, wherein said fuel cell system is operated in a motor vehicle.

8. The method according to claim 7, wherein the fuel cell system is operated as an auxiliary power unit (APU).

9. The method according to claim 7, wherein the fuel cell system is operated at least as part of the driving system of the motor vehicle.

10. A method of operating a fuel cell system that includes at least one fuel cell whose operating temperature is controlled by a cooling circuit having a cooling heat exchanger, said method comprising:
determining an ambient temperature at said heat exchanger;
controlling the operating temperature of said at least one fuel cell to maintain a difference between said operating temperature and said ambient temperature at a lowest value which is sufficient to assure removal of excess heat generated by a load applied to said at least one fuel cell.
